(19) United States
(12) Patent Application Publication
(10) Pub. No.: US 2026/0051671 A1
(43) Pub. Date: Feb. 19, 2026

(54) TERMINAL-ATTACHED ELECTRIC WIRE AND METHOD OF MANUFACTURING THEREOF

(71) Applicant: Yazaki Corporation, Tokyo (JP)

(72) Inventors: Kazuma WATANABE, Shizuoka (JP); Naoki ITO, Shizuoka (JP)

(73) Assignee: Yazaki Corporation, Tokyo (JP)

(21) Appl. No.: 19/294,841

(22) Filed: Aug. 8, 2025

(30) Foreign Application Priority Data
Aug. 15, 2024 (JP) 2024-135596

(51) Int. Cl. H01R 4/18; H01R 43/04

(52) U.S. Cl. CPC H01R 4/184; H01R 43/04

(57) ABSTRACT

A terminal-attached electric wire includes: an electric wire having a conductor and an electric-wire covering material for covering the conductor; and a terminal connected to the conductor of the electric wire. The terminal includes: a conductor crimping portion in contact with the conductor; and a protrusion in contact with the conductor and extending from the conductor crimping portion toward the electric-wire covering material.

### CROSS-REFERENCE TO RELATED APPLICATIONS

The present application is based on, and claims priority from the prior Japanese Patent Application No. 2024-135596, filed on Aug. 15, 2024, the entire contents of which are incorporated herein by reference.

### TECHNICAL FIELD

The present disclosure relates to a terminal-attached electric wire and a method of manufacturing thereof.

### BACKGROUND

Automobiles are equipped with a wide variety of electronic devices, and wire harnesses are routed to transmit power or control signals to the electronic devices. The wire harnesses include a plurality of electric wires and connectors, and are connected to the electronic devices or other wire harnesses by fitting the connectors to the connectors of the electronic devices or other wire harnesses. A terminal-attached electric wire used in forming such a wire harness generally includes electric wires and terminal metal fittings attached to the ends of the electric wires.

In order to improve the productivity and delivery efficiency of the terminals, chain terminals in which a plurality of terminals are integrally connected, and each terminal is separated from a carrier (chain) when used, are widely known. Conventionally, chain terminals having a linear chain and a plurality of terminals arranged in a direction orthogonal to the length direction of the chain are known (see JP2022-37547 A).

### SUMMARY OF THE INVENTION

Changing the shape of the terminals or the shape of swaging die has been studied as a means of improving the electrical performance of terminals crimped with coated wires. However, in the case of existing terminals as in JP2022-37547 A, it is difficult to change the shape of the terminals due to the die.

The present disclosure has been made in view of such problems in the conventional technology. It is an object of the present disclosure to provide a terminal-attached electric wire and a method of manufacturing thereof, which improve the electrical performance while minimizing the change in the shape of the terminal.

The terminal-attached electric wire according to the present embodiment includes an electric wire having a conductor and an electric-wire covering material for covering the conductor; and a terminal connected to the conductor of the electric wire; in which the terminal includes a conductor crimping portion in contact with the conductor, and a protrusion in contact with the conductor and extending from the conductor crimping portion toward the electric-wire covering material.

A method of manufacturing the terminal-attached electric wire according to the present embodiment in a chain terminal including a plurality of terminals; a chain formed in a straight line; and a plurality of joints extending from one side of the chain in a width direction toward the plurality of terminals in a direction orthogonal to a length direction of the chain and formed integrally with the conductor crimping portion of the terminals; includes: a step of separating the terminals by cutting the joints of the chain terminal in a width direction so that protrusions are formed; and a step of crimping a conductor, which is exposed by removing the electric-wire covering material of an electric wire, using the conductor crimping portion of the terminal.

According to the present disclosure, it is possible to provide a terminal-attached electric wire and a method of manufacturing thereof which improves electrical performance while minimizing the change in the shape of the terminals.

### BRIEF DESCRIPTION OF DRAWINGS

FIG. 1 is a plan view of a chain terminal in a method of manufacturing a terminal-attached electric wire according to the present embodiment.

FIG. 2 is a perspective view of the chain terminal in the method of manufacturing a terminal-attached electric wire according to the present embodiment.

FIG. 3 is an enlarged view of a joint of the chain terminal in FIG. 2.

FIG. 4 is a perspective view illustrating the state of a terminal before connecting an electric wire in the terminal-attached electric wire obtained in the manufacturing method according to the present embodiment.

FIG. 5A is an optical micrograph illustrating an upper side of a conductor crimping portion after crimping the conductor in the terminal-attached electric wire according to the present embodiment.

FIG. 5B is an optical micrograph illustrating the bottom side of the conductor crimping portion in FIG. 5A.

FIG. 6A is an optical micrograph illustrating a cross section along line A-A in FIG. 5A.

FIG. 6B is an optical micrograph illustrating a cross section along line B-B in FIG. 5A.

FIG. 7 is a plan view of an expanded loose terminal in the terminal-attached electric wire according to this embodiment.

FIG. 8 is a plan view illustrating a state of a loose terminal before connecting the electric wire in the terminal-attached electric wire obtained in the manufacturing method according to this embodiment.

FIG. 9 is a perspective view illustrating the state of the loose terminal before connecting the electric wire in the terminal-attached electric wire obtained in the manufacturing method according to this embodiment.

FIG. 10 is a graph illustrating the relationship between a voltage drop ratio and the length of a protrusion in the terminal-attached electric wire according to this embodiment.

### DETAILED DESCRIPTION OF THE INVENTION

A terminal-attached electric wire according to this embodiment will be described in detail below with reference to the drawings. The dimensional ratios in the drawings are exaggerated for the sake of explanation and may differ from the actual ratios.

### [Terminal-Attached Electric Wire]

The terminal-attached electric wire according to this embodiment will be described below. The terminal-attached electric wire includes an electric wire 10 having a conductor 11 and an electric-wire covering material 12 for covering the conductor 11, and a terminal 20 connected to the conductor 11 of the electric wire 10.

Materials having high conductivity such as copper, copper alloy, aluminum or aluminum alloy, for example, can be used for the conductor 11 of the electric wire 10.

A resin capable of securing electrical insulation can be used as a material of the electric-wire covering material 12 for covering the conductor 11. For example, a resin containing polyvinyl chloride (PVC) as a main component or an olefinic resin can be used. Specific examples of the olefinic resin include polyethylene (PE), polypropylene (PP), ethylene copolymer, and propylene copolymer.

The terminal 20 in the terminal-attached electric wire includes a conductor crimping portion 22 in contact with the conductor 11, and a protrusion 41 in contact with the conductor 11 and extending from the conductor crimping portion 22 toward the electric-wire covering material 12.

Metals having high conductivity can be used as materials (terminal materials) of the terminal 20. For example, at least one of copper, copper alloy, stainless steel, tin-plated copper, tin-plated copper alloy, or tin-plated stainless steel can be used. At least one of gold-plated copper, copper alloy, and stainless steel can be used, and at least one of silver-plated copper, copper alloy, and stainless steel can be used. Note that the terminal 20 preferably includes copper or copper alloy.

The terminal 20 may include a terminal body 21 to which a mating terminal (not illustrated) is connected. The terminal body 21 may be of a female type, for example, and may have an electric connection connected to the mating terminal. Furthermore, the electric connection may have a box-like appearance, and may have a built-in spring piece engaged with the mating terminal.

The terminal 20 has a conductor crimping portion 22 in contact with the conductor 11. The conductor crimping portion 22 of the terminal 20 is connected to a terminal portion of the electric wire 10 by swaging. The terminal-attached electric wire is obtained by connecting the conductor crimping portion 22 to the terminal portion of the electric wire 10. Specifically, the conductor crimping portion 22 is in contact with the conductor 11, which is exposed by removing the electric-wire covering material 12 at the terminal portion of the electric wire 10. As illustrated in FIG. 4, the conductor crimping portion 22 includes a bottom plate and a pair of conductor swage pieces extending upward, and is formed in a substantially U-shape in cross section. The conductor crimping portion 22 is bent inward to swage the conductor 11 of the electric wire 10 in an enclosing manner.

The terminal 20 of the terminal-attached electric wire is in contact with the conductor 11 and has the protrusion 41 extending from the conductor crimping portion 22 toward the electric-wire covering material 12. The protrusion 41 is formed continuously from the bottom plate of the conductor crimping portion 22. Due to the structure having the protrusion 41, it is preferable that the terminal 20 not be provided with a covering crimping portion in contact with the electric-wire covering material 12 of the electric wire 10.

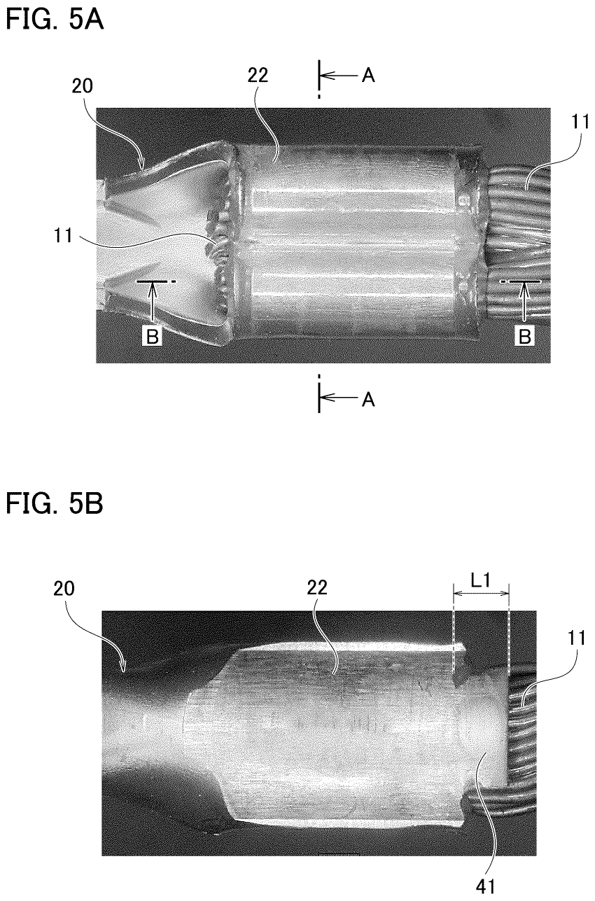

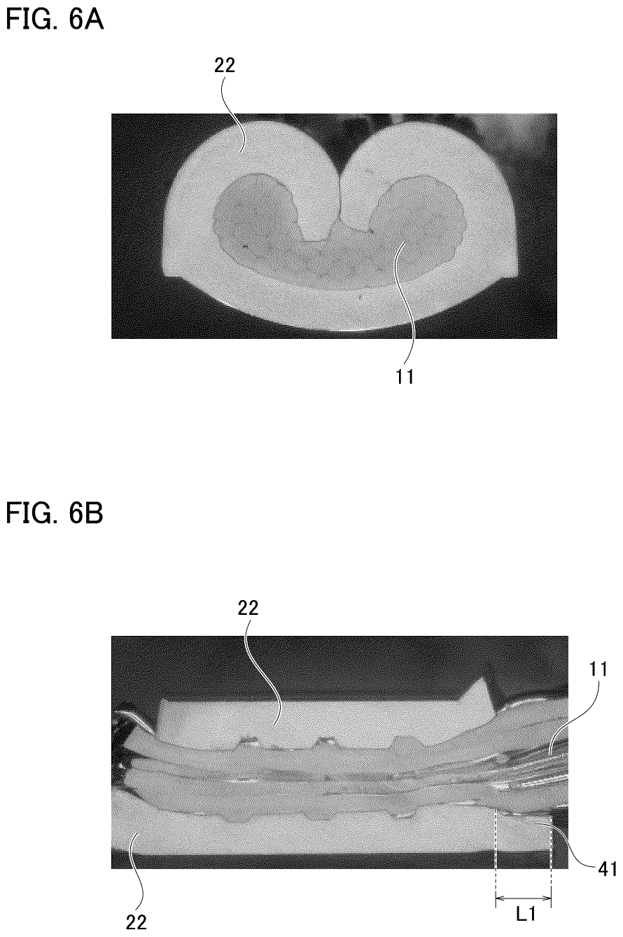

As illustrated in FIG. 4, in the terminal-attached electric wire, the conductor crimping portion 22 and the terminal portion of the electric wire 10 are pressed to deform the conductor crimping portion 22 after the terminal portion of the electric wire 10 is inserted into the conductor crimping portion 22 of the terminal 20. Then, as illustrated in FIGS. 5A, 5B, 6A, and 6B, a pair of conductor swage pieces for the conductor crimping portion 22 are bent inward to enclose the conductor 11, thereby swaging the conductor 11 in close contact with the upper surface of the bottom plate of the conductor crimping portion 22. In this way, the terminal 20 and the electric wire 10 are connected by crimping, and the terminal-attached electric wire is obtained. Furthermore, as illustrated in FIGS. 5B and 6B, when the conductor 11 of the electric wire 10 is swaged by the conductor crimping portion 22, the protrusion 41 comes into contact with the conductor 11 of the electric wire 10.

The terminal 20 has the protrusion 41, and a flat part like a flat surface which is longer than an upper surface by a length L1 is provided on a bottom surface of a rear end of the conductor crimping portion 22. The rear end of the conductor crimping portion 22 is an end of the electric wire 10 on the electric-wire covering material 12 side. When the conductor 11 of the electric wire 10 is swaged by the conductor crimping portion 22, a force to press the electric wire 10 by the terminal 20, that is, a contact pressure is efficiently transmitted from the terminal 20 to the electric wire 10. Therefore, when the terminal 20 is manufactured from the chain terminal as described below, it is not necessary to change the shape of the chain terminal already used, such as by increasing the width of the conductor crimping portion 22 of the terminal 20, in order to improve the electrical performance, nor is it necessary to change the terminal mold.

The length of the protrusion 41 is preferably 0.5 mm or more, and 1.0 mm or less. By making the length of the protrusion 41 0.5 mm or more, the contact pressure from the terminal 20 to the electric wire 10 can be increased to improve the electrical performance. In addition, by making the length of the protrusion 41 1.0 mm or less, it is possible to prevent adverse effects when arranging the terminals.

The terminal 20 may be manufactured as a loose terminal controlled to the shape of the terminal as described above. Furthermore, as described below, the terminal 20 may be manufactured by separating the terminals by cutting the joints of the chain terminal provided with a plurality of terminals connected to the chain.

As described above, the terminal-attached electric wire according to this embodiment includes the electric wire 10 having the conductor 11 and the electric-wire covering material 12 for covering the conductor 11; and the terminal 20 connected to the conductor 11 of the electric wire 10. The terminal 20 includes the conductor crimping portion 22 in contact with the conductor 11; and the protrusion 41 in contact with the conductor 11 and extending from the conductor crimping portion 22 toward the electric wire 10. Due to the terminal 20 having the protrusion 41, the contact pressure is efficiently transmitted from the terminal 20 to the electric wire 10 when the conductor 11 is swaged by the conductor crimping portion 22. Therefore, it is not necessary to substantially change the shape of the already used terminal in order to improve the electrical performance. From the above, the terminal-attached electric wire according to the present embodiment can improve electrical performance while minimizing the change in the shape of the terminal.

### [Method of Manufacturing Terminal-Attached Electric Wire]

Next, a method of manufacturing a terminal-attached electric wire according to the present embodiment will be described. In the method of manufacturing a terminal-attached electric wire, the terminal-attached electric wire may be manufactured from the chain terminal 1A.

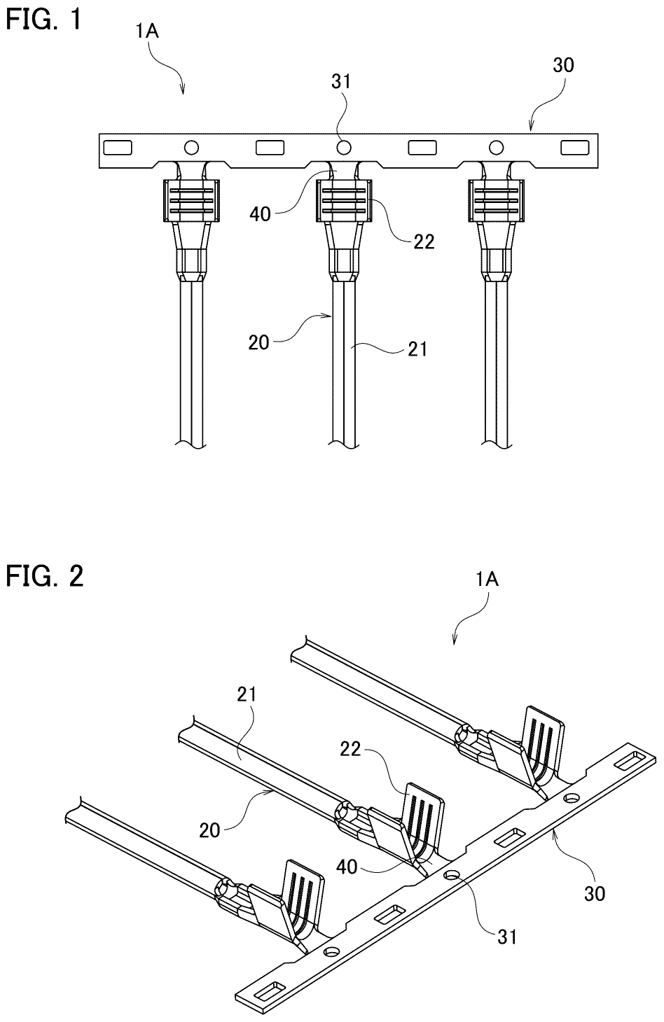

As illustrated in FIGS. 1 and 2, the chain terminal 1A includes a plurality of the terminals 20 and a chain 30 formed in a straight line. The chain terminal 1A further includes a plurality of joints 40 extending from one side of the chain 30 in a width direction, toward the plurality of terminals 20 in a direction orthogonal to the length direction of the chain 30. The plurality of joints 40 are integrally formed with the conductor crimping portion 22 of the terminal 20.

The chain terminal 1A is manufactured from a metal plate by pressing. During the pressing, holes 31 may be formed in the chain 30 for each terminal 20. For example, claws of a press device (not illustrated) may be inserted into the holes 31 to support the chain 30. The chain terminal 1A may be stored in a state where the chain 30 is wound in a reel shape in a factory or the like.

The method of manufacturing the terminal-attached electric wire according to the present embodiment includes a step (Step (a)) of separating the terminals 20 by cutting the joints 40 of the chain terminal 1A in a width direction so that the protrusions 41 are formed. The method of manufacturing the terminal-attached electric wire further includes a step (Step (b)) of crimping the conductor 11, which is exposed by removing the electric-wire covering material 12 of the electric wire 10, using the conductor crimping portion 22 of the terminal 20. The steps will be described below.

### Step (a)

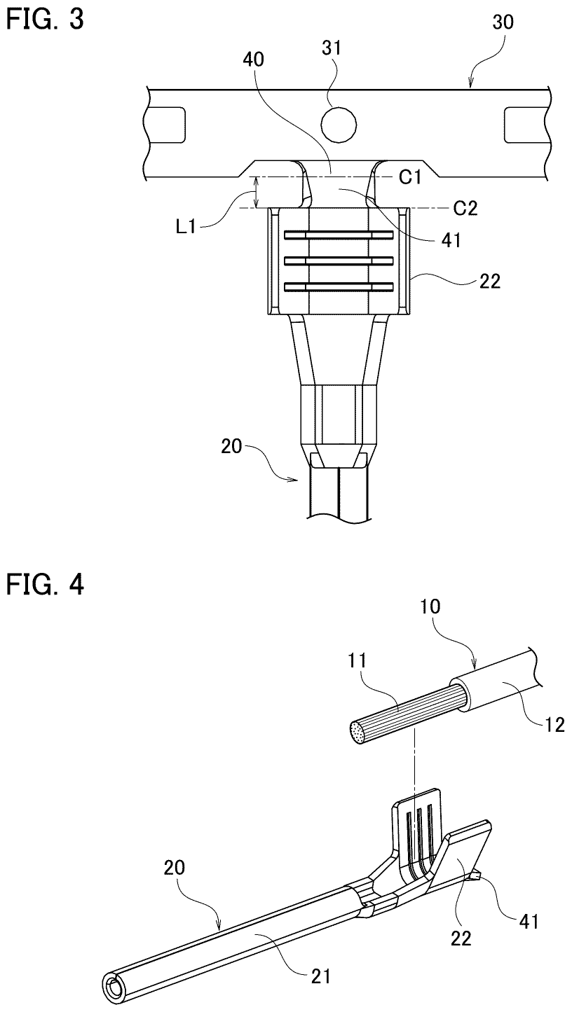

In Step (a), the terminals 20 are separated by cutting the joints 40 of the chain terminal 1A in a width direction so that the protrusions 41 are formed. FIG. 3 is an enlarged view of the joint 40 of the chain terminal 1A. When the terminal 20 is separated from the chain terminal 1A, the terminal used to be cut at a rear end of the terminal 20 (conductor crimping portion 22), that is, at a cutting position C2 so that the separation portion (cut-off tab) from the chain terminal 1A, is as short as possible. However, in the manufacturing method according to the present embodiment, the terminal 20 having the protrusion 41 is produced by cutting the joint 40 at a cutting position C1, securing a portion of length L1, and then separating the terminal 20.

### Step (b)

In Step (b), the conductor 11, which is exposed by removing the wire covering material 12 of the electric wire 10, is crimped by the conductor crimping portion 22 of the terminal 20. The terminal portion of the electric wire 10 is inserted into the conductor crimping portion 22 of the terminal 20 obtained in Step (a), and the conductor 11 of the electric wire 10 is placed on an upper surface of a bottom plate of the conductor crimping portion 22. The conductor crimping portion 22 is deformed by pressing the conductor crimping portion 22 and the terminal portion of the electric wire 10. Furthermore, by bending the pair of conductor swage pieces of the conductor crimping portion 22 inward to enclose the conductor 11, the conductor 11 is swaged in close contact with the upper surface of the bottom plate of the conductor crimping portion 22. In this way, the terminal 20 and the electric wire 10 are crimped and connected, and the terminal-attached electric wire with the protrusion 41 in contact with the conductor 11 is obtained.

As described above, in the method of manufacturing the terminal-attached electric wire of this embodiment, the terminal-attached electric wire may be manufactured from the chain terminal 1A. The manufacturing method includes a step of separating the terminals 20 by cutting the joints 40 of the chain terminal 1A in a width direction to form the protrusions 41. The manufacturing method further includes a step of crimping the conductor 11, which is exposed by removing the electric-wire covering material of the electric wire 10, by the conductor crimping portion 22 of the terminals 20. The terminals 20 having the protrusions 41 can be manufactured by adjusting the cutting position when separating the terminals 20 from the chain terminal 1A. Due to the terminal 20 having the protrusion 41, the contact pressure is efficiently transmitted from the terminal 20 to the electric wire 10 when the conductor 11 is swaged by the conductor crimping portion 22. Therefore, when manufacturing the terminals 20 from the chain terminal 1A, it is not necessary to change the shape of the chain terminal already used, such as by increasing the width of the conductor crimping portion 22 of the terminals 20, in order to improve the electrical performance, nor is it necessary to change the terminal mold. Thus, in the method of manufacturing the terminal-attached electric wire according to the present embodiment, it is possible to provide a method of manufacturing the terminal-attached electric wire in which the electrical performance is improved by minimizing the change in the shape of the terminal.

Furthermore, the terminal-attached electric wire according to the present embodiment may be manufactured from a loose terminal 1B. The description of the same parts as in the case of manufacturing the terminal-attached electric wire from the chain terminal 1A will be omitted or simplified.

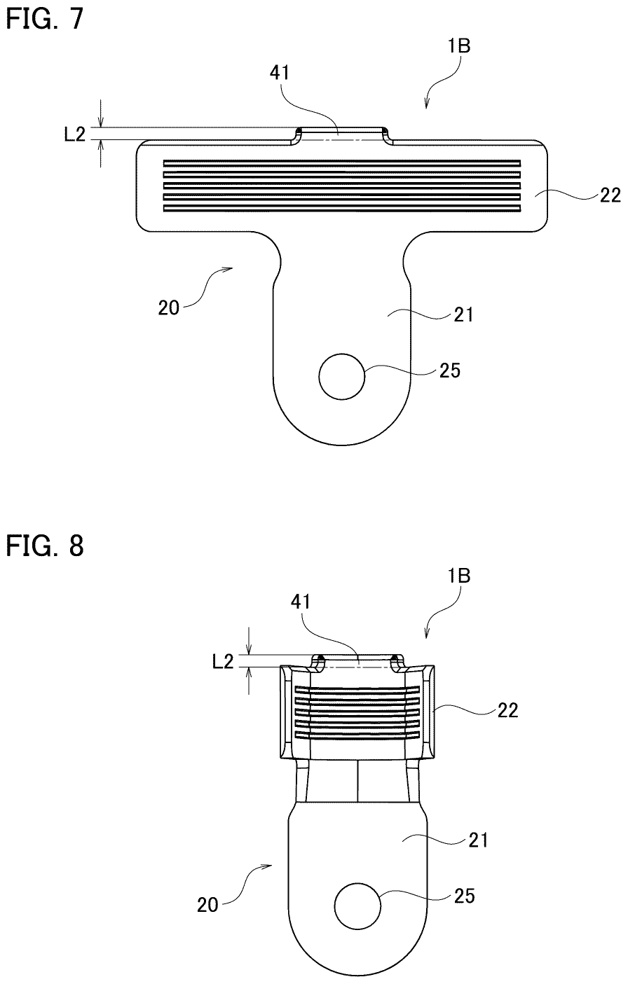

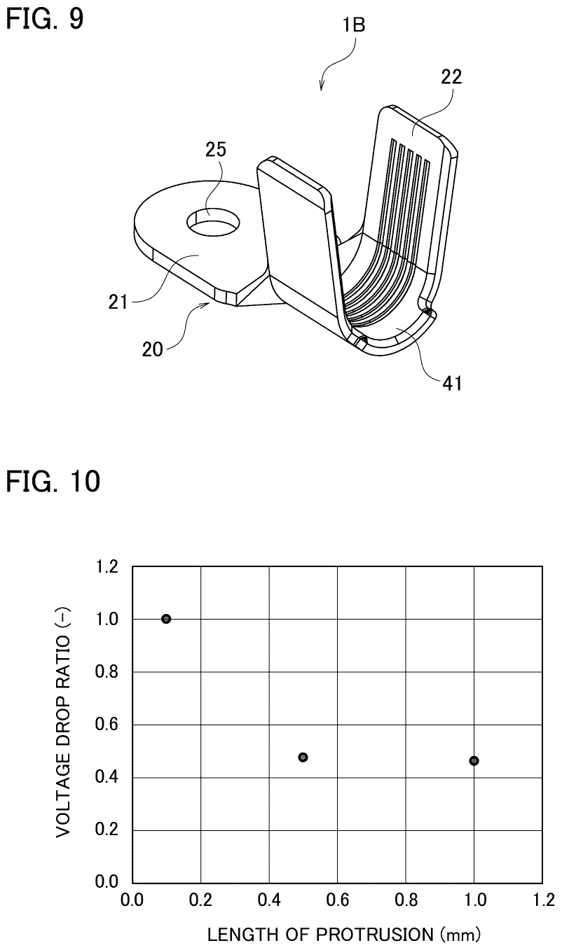

As illustrated in FIGS. 7 to 9, the loose terminal 1B is manufactured by controlling the shape of a terminal so that the protrusion 41 having a length L2 is formed. Therefore, when the terminal-attached electric wire is manufactured from the loose terminal 1B, Step (a) described above is not necessary, and the manufacturing method includes Step (b), that is, a step of crimping the conductor 11, which is exposed by removing the electric-wire covering material 12 of the electric wire 10, using the conductor crimping portion 22 of the terminal 20.

Like the terminal 20, the loose terminal 1B in the terminal-attached electric wire includes the conductor crimping portion 22 in contact with the conductor 11, and the protrusion 41 in contact with the conductor 11 and extending from the conductor crimping portion 22 toward the electric-wire covering material 12.

The shape of the loose terminal 1B (terminal 20) is not particularly limited, and may include the terminal body 21 having holes 25 penetrating front and back surfaces. Fastening members such as bolts and screws are inserted into the holes 25, fastened and fixed to the connecting portions of various devices, thus becoming electrically connected. The shape of the holes 25 formed in the loose terminal 1B (terminal 20) is not particularly limited and may be male, female, or LA (round) type, for example.

In the loose terminal 1B (terminal 20), the conductor 11 is swaged by the conductor crimping section 22 in the same manner as in Step (b) described above, whereby the loose terminal 1B (terminal 20) and the electric wire 10 are crimped and connected, and the terminal-attached electric wire with the protrusion 41 in contact with the conductor 11 is obtained. Due to the loose terminal 1B (the terminal 20) having the protrusion 41, the contact pressure is efficiently transmitted from the terminal 20 to the electric wire 10 when the conductor 11 is swaged by the conductor crimping portion 22. Therefore, it is not necessary to substantially change the shape of the already used terminal in order to improve the electrical performance. From the above, the terminal-attached electric wire according to the present embodiment can improve electrical performance while minimizing the change in the shape of the terminal even when the terminal is manufactured from the loose terminal 1B.

### Examples

Hereinafter, this embodiment will be described in more detail using examples, but this embodiment is not limited to these examples.

### (Preparation of Test Samples)

A chain terminal was prepared, and terminals with different lengths of protrusions were produced by adjusting the cutting position in Step (a) described above. Specifically, the length of the protrusions was set to 3 types, 0.1 mm, 0.5 mm, and 1.0 mm. Then, in Step (b), test samples of the terminal-attached electric wires with a protrusion in contact with a conductor were obtained.

### (Voltage Drop Ratio)

The electrical performance of the terminal-attached electric wires was evaluated by the voltage drop value generated at the conductor crimping portion after the terminal crimping. The voltage drop value is considered to be mainly caused by the contact resistance at the contact point between the conductor and the conductor crimping portion. The lower the voltage drop value, the better the electrical performance.

The voltage drop value of the conductor crimping portion was calculated by subtracting the voltage drop value of the conductor alone from the measured value after measuring the voltage drop value of the terminal-attached electric wire. Then, the voltage drop value was set to 1.0 when the length of protrusion is 0.1 mm, and the voltage drop ratio was determined. FIG. 10 is a graph illustrating the relationship between the voltage drop ratio and the length of the protrusion 41. The voltage drop ratio was 0.48 when the length of the protrusion was 0.5 mm and 0.46 when the length of the protrusion was 1.0 mm. From these results, it can be seen that the electric performance was improved by the terminal-attached electric wire having the protrusion.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A terminal-attached electric wire comprising
an electric wire having a conductor and an electric-wire covering material for covering the conductor, and
a terminal connected to the conductor of the electric wire, wherein
the terminal includes: a conductor crimping portion in contact with the conductor; and a protrusion in contact with the conductor and extending from the conductor crimping portion toward the electric-wire covering material.

2. The terminal-attached electric wire according to claim 1, wherein the length of the protrusion is 0.5 mm or more, and 1.0 mm or less.

3. A method of manufacturing a terminal-attached electric wire according to claim 1 in a chain terminal including a plurality of the terminals; a chain formed in a straight line; and a plurality of joints extending from one side of the chain in a width direction toward the plurality of terminals in a direction orthogonal to a length direction of the chain, and formed integrally with the conductor crimping portion of the terminals, comprising:
a step of separating the terminals by cutting the joints of the chain terminal in a width direction so that the protrusions are formed, and
a step of crimping the conductor, which is exposed by removing the electric-wire covering material of the electric wire, using the conductor crimping portion of the terminal.
